(19) United States
(12) Patent Application Publication
(10) Pub. No.: US 2009/0084808 A1
(43) Pub. Date: Apr. 2, 2009

(54) Hand held counting system for tablets and capsules

(76) Inventor: Kevin F. Stanley, Mechanicsville, VA (US)

Correspondence Address: Kevin F. Stanley, 11100 Dixie Lane, Mechanicsville, VA, 23116, US

(21) Appl. No.: 11/904,381

(22) Filed: Sep. 28, 2007

(51) Int. Cl. B65G 69/22

(52) U.S. Cl. 221/1; 221/7

(57) ABSTRACT

A curved or multisided bowl like counting device with a flat inner surface which may have raised dividers or lines such that tablets or capsules poured into said device in quantities of 10 to 15 at a time can be easily counted by visual discernment of groupings of two's, three's, four's, five's, six's, seven's or eight's.

### BACKGROUND

1. Field of the Invention

This invention relates to the counting of tablets and capsules for the dispensing of pharmaceuticals in pharmacies and other health care facilities.

2. Description of Prior Art

When a health care practitioner orders medication for a patient that comes in the form of a tablet or capsule the quantity to be dispensed must frequently be counted out by the provider. Most frequently this function is preformed by a pharmacist or pharmacy technician, but may be preformed by others, such as physicians and their staff or veterinarians and their staff.

Currently, this counting is most frequently done by the use of a counting tray, which consists of a small tray with a trough on one end. Items to be counted are poured onto the tray, then pushed into the trough as they are counted, usually five at a time, until the desired quantity is counted. Extras are then poured back into the stock bottle from the tray and the counted quantity is poured from the trough into the dispensing bottle. This method is effective but somewhat cumbersome since it requires multiple steps plus the use of both the tray and the spatula. Other methods of counting involve the use of electronic devices which count mechanically, or use light technology, or weight technology. These methods are effective but have drawbacks, the most significant of which is cost.

### OBJECTS AND ADVANTAGES

Accordingly, the objects and advantages of my invention are:
(a) To provide a simple alternative to the use of the traditional counting tray.
(b) To provide an inexpensive counting system whose implementation will involve a minimal cost for its users.
(c) To improve efficiency in the dispensing process by providing a quicker method for counting tablets and capsules.
(d) Further objects and advantages are to provide a new item, which will be attractive for promotional uses by vendors due to its relatively low cost and high utility value. Still further objects and advantages will become apparent from a consideration of the ensuing description and drawings.

### DRAWING FIGURES

FIG. 1-A shows a view of the system from above.

FIG. 1-B shows a view of the system from the side.

FIG. 2 shows a view of the system from above with tablets in place for counting.

FIG. 3 shows the system as in FIG. 1-A but with inner dividers

FIG. 4 shows cross sectional view with no dividers.

FIG. 5 shows the system as in FIG. 1-A but with lines marked to aid in counting.

### REFERENCE NUMERALS IN DRAWINGS

12 Outside rim of system
13 Low ridge at open side
14 Divided inner sections

### SUMMARY

In accordance with the present invention a hand held counting system for tablets and capsules comprises a multisided or curved, concave bowl-like device 1.5 to 4 inches in diameter with a flat inner surface, and being open sided at one end except for a low ridge across said opening, possibly with raised dividers which create three sections inside the bowl. Tablets or capsules are visually counted on said flat inner surface and then poured out said open side with low ridge. Said low ridge helps to contain said tablets and capsules during counting.

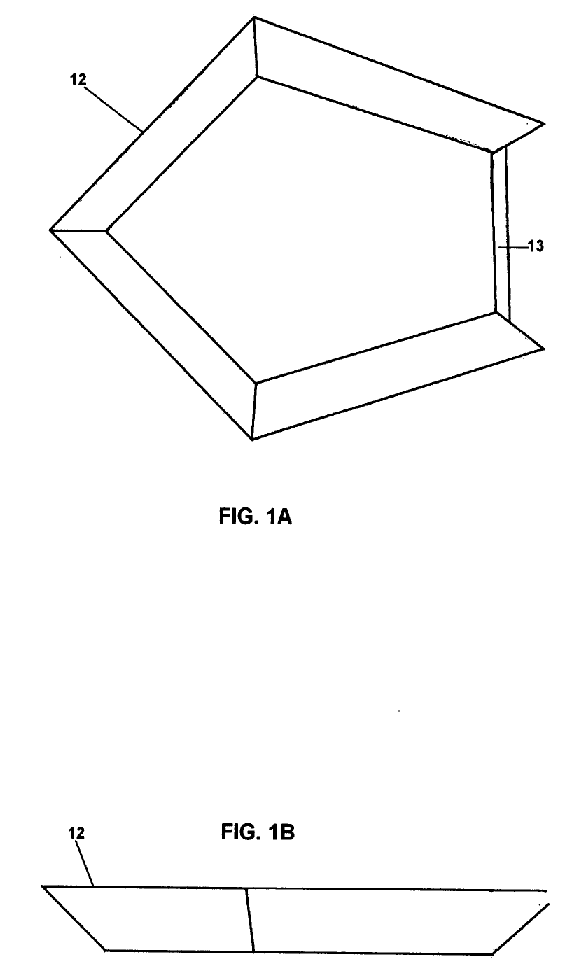

### DESCRIPTION—FIGS. 1 TO 3

A typical embodiment of the counting system is shown in FIG. 1-A (perspective from above) and FIG. 1-B (perspective from side). The system is composed of a plastic, metal or other material, which may either be hard or flexible, of thickness from 0.0625 inch to 0.25 inch. The inner dividers are of width approximately 0.125 to 0.33 inch and of height approximately 0.125 to 0.33 inch and composed of the same material. The system itself could be a bowl with flat inner surface of circular, oblong or irregular shape, however the current embodiment is a bowl of polygon shape with flat inner surface which is based on a pentagon with sides of length 1.25 to 2.00 inches at the base and 1.5 to 3.00 inches at the rim. The side walls are of width 0.25 to 0.75 inch. The angle of said side walls with respect to the inner surface is from 110 to 160 degrees. Two sides of the pentagon are elongated equally to a length of 1.5 to 3.5 inches at the base and 1.875 to 4.00 inches at the rim, with the top dimension extending beyond the length of the base dimension so that these wall sections form tabs extending beyond the opening to function as part of the pouring spout. The final side of the pentagon is of a shorter length, which is determined by the exact dimensions of the other sides. This short side forms the pouring spout for this embodiment of the system and has a very low side wall of 0.0625 to 0.25 inch in width in order for this side to function as a pouring spout.

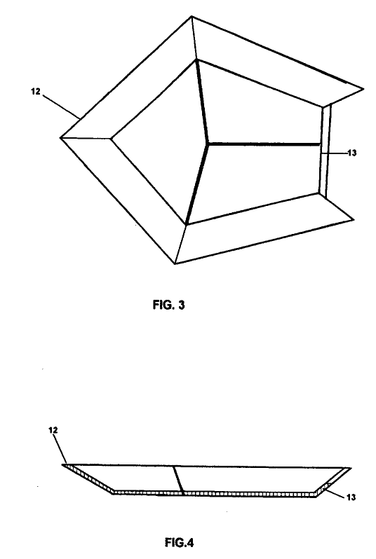

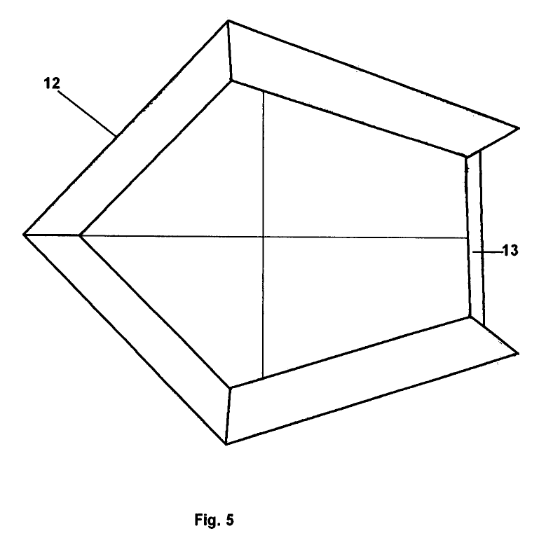

Another embodiment of the system (FIG. 3) is composed of similar material and similar dimensions, but has the additional feature of inner dividers. The inner dividers are of width approximately 0.125 to 0.33 inch and of height approximately 0.125 to 0.33 inch and composed of the same material. They divide the inner surface into three equal areas and facilitate ease of counting.

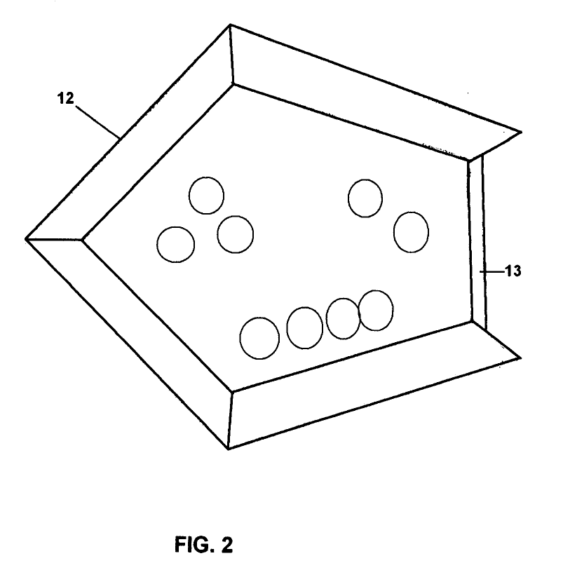

### OPERATION—FIG. 2

The manner of using the hand held counting system for tablets and capsules is as follows. Tablets or capsules to be counted are poured from the stock bottle into the counting system approximately 10 to 15 units at a time. The raised divider sections will separate these into smaller groupings of 3 to 6 per section, which can easily be counted by the eye and totaled. The embodiment of FIG. 1-A without inner dividers would still use the same visual technique of counting smaller groupings. These are then dumped from the counting system into a receptacle, which might be another counting system or the final dispensing bottle. The process is repeated again, keeping a running tally in the operator's head until the desired total is reached.

### Conclusions, Ramifications and Scope

Accordingly, the reader will see that the Hand Held Counting System for Tablets and Capsules can be used as a simple, fast and economic alternative to traditional methods for counting tablets and capsules. Additional advantages of the system include:

Elimination of need for spatula, which is required with traditional counting trays.

Easy adaptability to use by right handed or left handed individuals.

Although the description above contains many specificities, these should not be considered as limiting the scope of the invention, but as merely providing illustrations of some of the presently preferred embodiments of this invention. For example, the system may work equally well in size dimensions other than those sited, as well as other material compositions.

I claim:

1. A device for counting tablets and capsules comprising a bowl shaped structure of predetermined size, thickness and composition with a flattened inner surface whereby said tablets or capsules can be visually counted and then dumped into a receptacle until the desired quantity is counted out.

2. The device of claim 1 further including raised dividers arranged on said flattened inner surface whereby said tablets or capsules will tend to fall into groupings more easily counted by the eye.

3. The device of claim 1 further including lines marked and arranged on said flattened inner surface whereby said tablets or capsules will tend to fall into groupings more easily counted by the eye.

4. A method of visually counting objects comprising the steps of:
a. Placing the objects on a flattened surface having well defined borders in such a manner that the objects arrange themselves in patterns that can be visually detected to represent known quantities.
b. Counting said objects on said surface by summing said quantities.
c. Dumping said objects from said surface and repeating steps a and b until counting is completed.
